(19) United States
(12) Patent Application Publication
(10) Pub. No.: US 2005/0035233 A1
(43) Pub. Date: Feb. 17, 2005

(54) Walnut meat and other nut meat grinder

(76) Inventor: Steve Fredericks, Biggs, CA (US)

Correspondence Address: Mark C. Jacobs, 3033 El Camino Avenue, Sacramento, CA, 95821, US

(21) Appl. No.: 10/640,758

(22) Filed: Aug. 15, 2003

(51) Int. Cl. A47J 42/00

(52) U.S. Cl. 241/169.1

(57) ABSTRACT

A grinder for walnut and other nut segments which have been removed from the shell, which grinder resembles a physical configuration of a grinder for peppercorns. The grinder features a crank rotatable shaft connected to a grinding element disposed within a lower portion of a generally cylindrical housing. A series of spaced flutes is mounted on the interior surface of the lower portion of the apparatus to direct nut segments to the cutter. The grinder element is a rounded trapezoidal in elevation cutter having a series of bulging protrusions each with a sharp edge for mincing a nut segment. Each protrusion is adjacent an opening such that minced pieces pass through an opening to the center of the cutter which is open at the bottom. The grinding element top is closed off by a cutter holder and the cutter is connected to the aforementioned rotatable shaft.

### FIELD OF INVENTION

This application pertains to a grinder for nut meats, and especially walnut meats, which are the segments or pieces of nut or single nut such as a pecan that has been removed from the shell.

### BACKGROUND OF THE INVENTION

Grinders for peppercorns have been known for many years. Indeed in the last 15 years there have been numerous improvements in grinders for peppercorns. There have been improvements specifically in the grinding element for the peppercorns. There has NEVER, however, been a grinder specifically designed for the particle size reduction of segments of walnuts and other edible nuts that have been removed from the shell. Walnuts, almonds, and pecans are known to be highly nutritious for humans of all ages, due to high protein content, except of course to those who suffer from a specific food allergy to nuts. This number however is small compared to the total population. Thus, there is a real need to be filed by this device.

In attempting to create the world's first walnut meat grinder meat a review of the art relating to pepper grinders was undertaken. Among the patents that turned up during the course of an aptest search were:

| Inventor | Patent | Issued |
|---|---|---|
| Schmitz | 0,290,120 | Dec. 11, 1883 |
| Wellington | 0,040,971 | Dec. 15, 1863 |
| Leavitt | 0,220,626 | Oct. 14, 1879 |
| Klensch et al. | 1,768,076 | Jun. 24, 1930 |
| Kirkland | 2,376,603 | May 22, 1945 |
| Lenz | 2,688,448 | Sep. 7, 1954 |
| Wu | 6,378,794 | Apr. 30, 2002 |
| Fuller | 4,027,824 | Jun. 7, 1977 |

None of these references alone or in any combination anticipates or makes the invention of this application obvious to one of ordinary skill in the art, especially since all pertain to peppercorn particulate reduction.

### SUMMARY OF THE INVENTION

A nut meat grinder apparatus, configured physically similarly to a grinder for peppercorns, in that the nut meats, similar to the peppercorns, are put in at the top of the apparatus, moved to the bottom zone by gravity and reduced in size by a handle operated rotating shaft attached to a grinder element. Here, however, the segments of nut are allowed to settle between the cone shaped grinding element and the interior wall of the base of the apparatus. The grinder element is of a circular trapezoid shape with a smaller covered top surface and a larger open bottom surface. The nut meats are forced between the interior wall of the housing and the grinder. Wall mounted flutes direct the meats toward the grinder and its bladed openings. As the grinder is rotated by movement of the shaft in conjunction with the handle, the grinder reduces the particle size, while forcing the reduced in size segments through a series of elliptical openings in the cone shaped grinding element for delivery.

### BRIEF DESCRIPTION OF THE FIGURES

FIG. 1 is an exploded view of the apparatus of this invention.

FIG. 2 is a closeup perspective view of the lower portion of this apparatus.

FIG. 3 is a bottom view of the top section of the body portion.

FIG. 4 is an elevational diagrammatic cutaway view of the bottom section of the body of this invention.

FIG. 5 is a perspective view of the grinder element forming a part of this portion.

FIG. 6 is a bottom plan view of the bottom portion of this invention.

FIG. 7 is an elevational view of a variant of this invention.

FIG. 8 is an n elevational view of an optional bottom cap that serves as a catch for loose nut crumbles shown disposed on the bottom of the device.

FIG. 9 is a perspective view of a variant of the handle crank of this device.

### DESCRIPTION OF THE PREFERRED EMBODIMENT

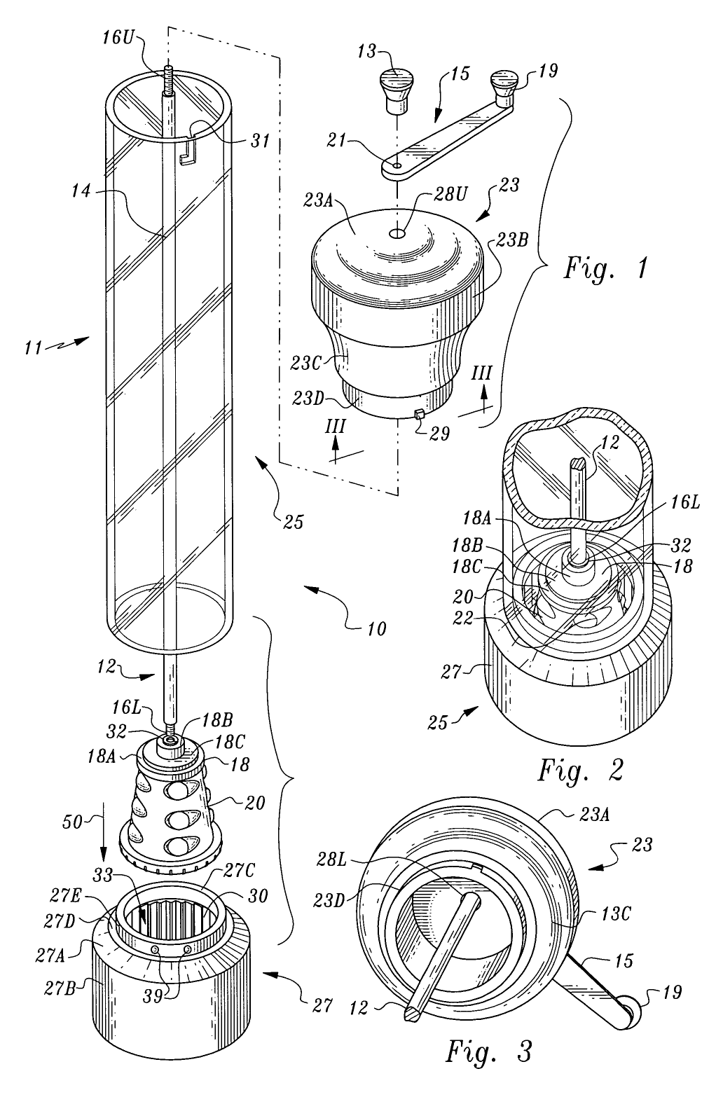

In FIG. 1, there is shown the apparatus of this invention in an elevated exploded view. This view is deemed exploded because all of the parts are shown in their logical location but disconnected from each other.

The apparatus 10 has a main body portion 11 and a cutter portion 12, the latter of which will be discussed infra. The main body 11 has an upper section 23 and a lower section 27 with an elongated tubular section 25 disposed in-between. Upper section 23 has a top arcuate surface 23A which has a central bore at the uppermost part, said bore being designated 28U. A second segment of a generally vertical circular wall section is disposed beneath the top segment and is designated 23B. An inwardly narrow cross section circular segment is disposed beneath the aforementioned second segment 23B. This third segment is designated 23D. This recessed upper lip 23D has an outwardly disposed rectangular boss or tab 29 extending upwardly from its bottom edge and which tab is used during the attachment of the upper section to the cylindrical tube 25. As will be seen this tab 29 is to be aligned with an L-shaped recess 31 on the edge of the central section, tube 25. See FIG. 1.

A tubular clear, preferably elongated; tube 25 is disposed beneath the body's upper section and above the body's lower section 27. Tube 25 matingly engages both sections. The central section 25 may be made of plastic such as acrylic or glass. Plastic is preferred for reasons of safety in case the apparatus is dropped so as to avoid shattering.

The body 11 terminates in a lower section 27, which also has a central lip or rim 27C of the same cross section as recessed lip 23D. It too is recessed from the outer edge of the balance of the lower section 27. The lower section 27 further includes and exterior area comprising an intermediate segment 27A and a bottom segment 27B both of which is of a circular cross section, though 27A has a tapering side wall.

It is important to understand that the exact configuration of the upper section and the lower section are of no real consequence. The only proviso is that each must have an inset lip or rim such as 23D in the upper section and 27C in the lower section. These act as a shoulder for insertion into the center tube 25 to achieve the mating engagement of the tube with the upper and lower sections.

The center 25 is disposed between the upper and lower body section. It too has a slit 31 that depends downwardly about ¼ inch. These slits 29,31 are used during the assembly process to bleed out air trapped during the nut segment loading process. A simple small rotation of the upper portion relative to the center tube closes off the center tube to avoid possible contamination.

We turn now to the cutter aspect or portion of the invention, but remaining with FIG. 1. As can be seen an elongated shaft 14 having threads at each end 16U and 16L, forms the connection between the crank 15 at the top and the dome or cone cutter 20. Crank 15 is a handle type element with a threaded opening 21 that threadedly engages the upper threads 16U of the shaft 12. This permits crank 15 to rotate the shaft 12. An optional knob 19 may be attached as by a screw—not seen, or a rivet to permit rotation of the knob, or the knob may be fixedly glued to the distal end of the crank 15. The main part of shaft 12 is designated 14 and is located within the center tube. This aspect of the shaft 12 which is visible after assembly may be of the same or different cross section as the balance of the shaft 12.

A cap nut 13 threadedly engages threads 16U to retain the crank in position on the shaft 12. The cap nut may be made of plastic or metal. The choice usually is chrome or brass plate over steel or vacuum metalized plastic such as nylon as may be desired.

The lower threads 16L engage a threaded base 18B in cutter cover 18. See also FIG. 2. Again, the exact configuration of the cutter cover 18 is unimportant. An optional lock washer 32 maybe engaged to the threads 16L to prevent disassembly of the shaft from the cutter cover.

As an alternative an acme-threaded rod wherein the threads at each direction of the shaft 12 are in the opposite direction may also be employed to prevent easy disassembly.

Here the cutter cover has a top section 18A of a first circular cross section connected to a second section 18B of a slightly wider cross section and a third section 18C sized in its interior diameter to receive the cone cutter 20 by press fit frictional engagement.

It is important to understand the basis for down arrow 50, which is seen near the bottom of FIG. 1. This is to indicate to the reader that the actual placement of the cone cutter 20 and the cutter cover 18 are actually within the bottom section as per FIG. 2, not up in the center tube 25 as shown in FIG. 1. This information arrow 50 is used to point out the “artistic license” discontinuity of the shaft 12 to help place the viewer in proper visual perspective. See also the discussion relative to FIG. 4. Note the interior central opening 33 of bottom portion 27.

In FIG. 3, the underside of the upper body portion 23 is seen as taken along the line III-III of FIG. 1. A center aperture 28L is seen, through which shaft 12 is disposed. This aperture aligns with the base aperture 28U seen in FIG. 1 in the arcuate surface 23A. This presupposes of course that upper portion 23 is hollow. If not, there needs to be a throughbore to communicate between aperture 28U and aperture 28L. Bottom portion 27 is generally annular having a large central opening into which the dome cutter 20 and the cutter holder 18 are dispensed.

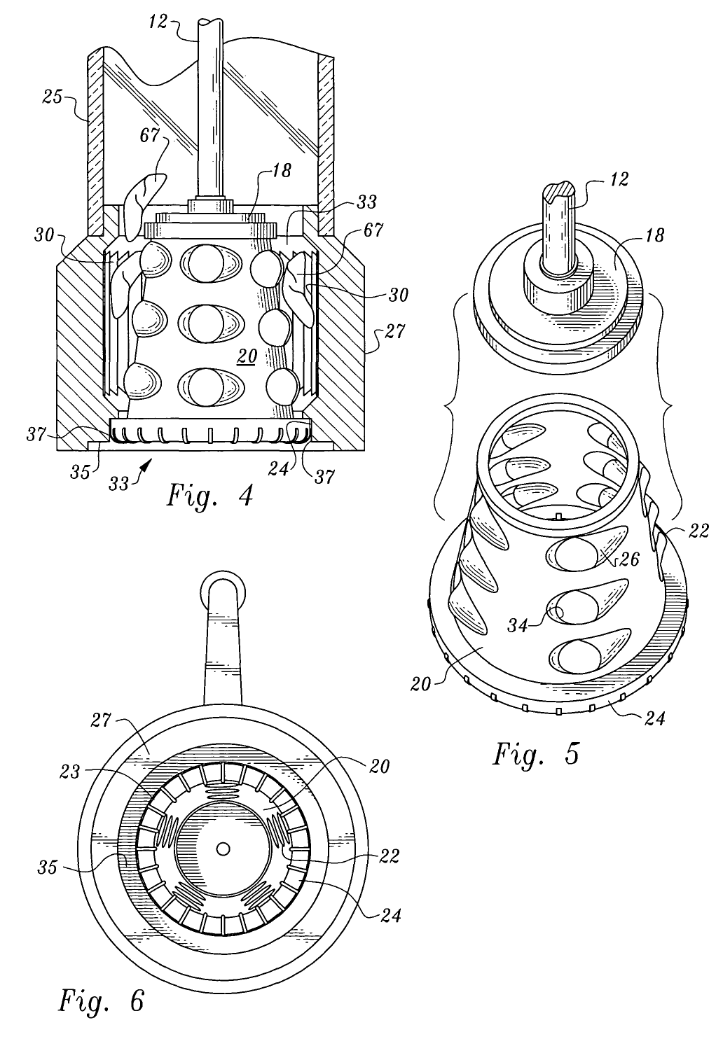

FIGS. 4,5, and 6 also show the edge protector 24 which is a piece of hard rubber or plastic that fits over the lower edge of the metal cutter 20 by friction fit to prevent finger injuries since the bottom opening of the apparatus 10 is finger accessible. Reference is made at this time to FIG. 6, which shows the edge protector 24 and the cone cutter 20 in their normal disposition, recessed up within the bottom opening 23 of lower body portion 27. The upwardly disposed interior lip of the bottom portion 27 is designated 35 while the little rim that extends inwardly and which is adjacent to the edge of the cutter's edge protector 24 is designated 37. Again reference is made to FIG. 6.

FIG. 4 is a diagrammatic view which illustrates the cutting procedure herein involved, as well as showing the correct vertical positioning of the several elements. The cone cutter 20 has a grinder element which is a rounded trapezoid in elevation having a series of bulging protrusions each with a sharp edge for mincing a nut segment. Each protrusion is adjacent an opening such that minced pieces pass through an opening to the center of the cutter which is open at the bottom will be described in full detail in the discussion of FIG. 5 is seen to be disposed within the lower body section 27. Disposed on the sidewall of the interior of the lower body section are at least two and up to about four wall mounted flutes 30. These are vertical pieces of metal or plastic which are about 0.50 inches high and 0.125 inches wide that extending outwardly from the interior surface of the bottom section, and which are not seen in FIG. 1. These flutes 30 serve as guides for nut meat halves or smaller segments 67 to engage the cutter 20. The flutes also guide entire pecans and other whole shelled nuts to engage the cutter 20.

Note also the presence of the cutter cover 18 to which the cone-shaped cutter is engaged as well as the presence of the shaft 12.

In FIG. 6, an alternate configuration for the cutter holder 18 is seen, though this is a less preferred version of the cutter holder. But in both views, the cutter is the same Shaft 12 again in FIG. 6, if present would be threadedly engaged to a center-threaded bore not seen of the cutter holder 18. The bottom edge protector 24 which is the same in both views is also illustrated in this figure.

The cutter 20 seen in FIG. 2 as well as in FIG. 6, is seen to be a steel cone having circular openings 22 and bullethead-shaped outward bulges 26 that serve to catch the nut meat section and wedge the nut meat between the flute and the wall of the cutter. These bullethead protrusions 26 have a sharpened edge 34 that are capable of mincing the nut such that once cut, the nut meat cut off section falls into the opening 22 to be dispensed out the opening 33, which serves as the exit mouth of the cutter 20.

One should note that preferably there are three cutting edges 26 in a vertical row on the cutter 20, followed by a laterally spaced second row of cutting edges located at a slight offset in elevation around the periphery of the cutter 20. There may be up to three such alternating two vertical row sets of cutting edges 26 present, though an odd number of rows are also contemplated. The offset insures that both relatively high and relatively low nut meats are cut by cutting edges 22. FIG. 6 shows six full vertical edges and part of three more such edges 26.

FIG. 7 illustrates a more sleek lined version of the cutter. All the same elements are present, though these designators have been numbered in the 100 series.

Thus the plastic center tube is shown as 125 while the shaft is 114, the bottom section 127, and the top section 123. Here the knob 119 is integrated into the crank 117 as an upstanding terminal end. The cap nut 113 serves the same function as cap nut 13 seen in FIG. 1. All other undiscussed elements of the variant of FIG. 7 are the same as those discussed in detail herein.

It can be seen by a comparison of FIGS. 1 and 7 that the actual configuration of the apparatus of this invention is not relevant, as long as the top section and bottom section retain a central tubular section, and the specific cutter element described in detail is used. It is thus the cutter element that allows this apparatus to succeed where others have failed. Nut meat halves and large pieces are minced by the cutting edge 34 on the protrusions 26 and forced out the bottom opening 33 for use in salads, sundaes, and other gourmet dishes.

While the device described herein employs a crank to rotate the shaft, and optionally includes a knob to make the rotation even easier than if only the crank were to be used, it is also within the scope of the invention to have the shaft fixedly disposed within the upper section, such that rotation of the entire upper portion, causes the shaft to rotate and to thereby rotate the cutter. While such a mode of upper section rotation of the shaft is well known in the peppercorn grinding art, it is believed that the larger segments of nuts, walnuts, and entire nuts, pecans or almonds, to be ground here, make the crank operated shaft as disclosed here preferably. This is due to the extra leverage available from the crank operation as opposed to the sheer rotational effort that is needed for the non-crank operated grinders.

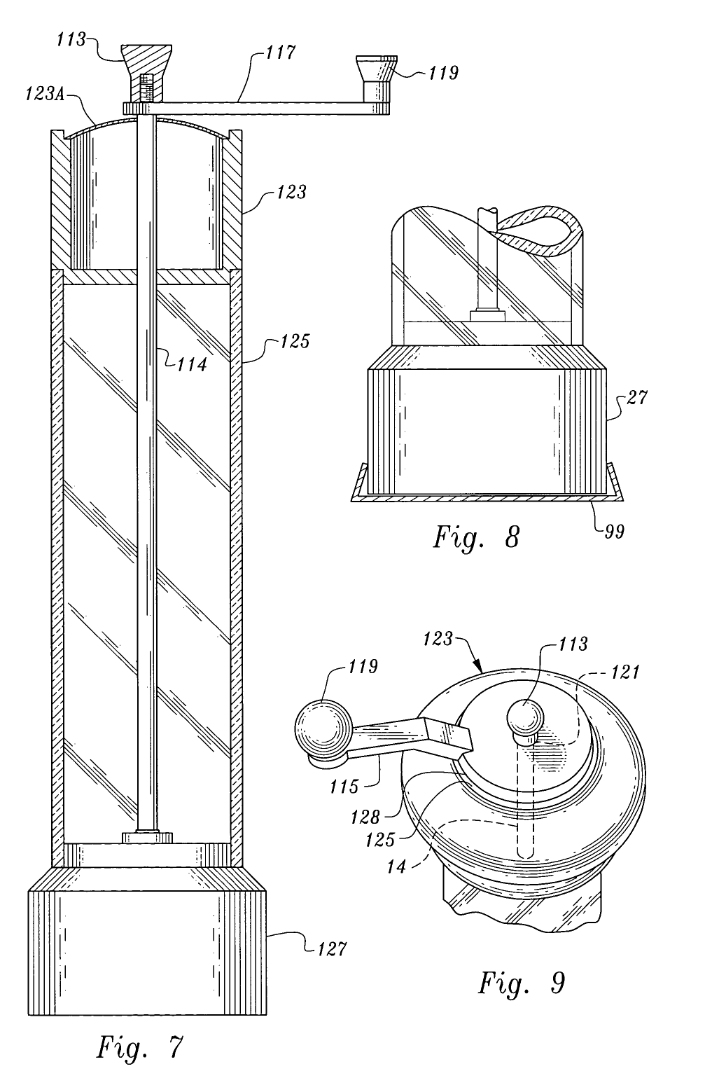

In FIG. 8, an optional snap fit catch cap 99 which has a slightly inwardly tapering side wall is seen disposed upon the bottom of the unit. The catch cap 99 serves as both a catch to receive any stray crumbles that may drop down after the actual grinding operation is completed, as well as to prevent moisture and other unknown materials from entering the open bottom space.

In FIG. 9, a variant for the handle crank is shown. Here the handle 115 has a knob 119 at the end thereof, similar to the handle 15 with its knob 19. But in this variant, the handle is dished upwardly and out, as opposed to being straight, and the handle crank is integrated into a decorative overlay 121, for the upper section here designated 123. The overlay and the crank are manufactured as a one piece unit. Overlay 121 has a slightly inwardly recessed downwardly depending lip 128 that fits into a top circular recess 125 of this upper section 123. A central bore 122 in the overlay 121 serves to receive the protruding shaft 14 for engagement with cap nut 113.

### ASSEMBLY

The attachment of the crank to rotate the shaft has been discussed at length. Either variant will achieve the same result, namely turning of the shaft. It is to be that the bottom portion is glued to the central tube along upstanding edge 27E. Dots 39 represent glue dots used to permanently affix the tube to the bottom section. The upper section 23, and the upper section 123, both utilize a turn and lock releasable attachment mode. See FIG. 1. The tab or boss extends outwardly on surface 23D for mating engagement of the interior L recess of the cental tube 25. Thus when refill of the tube with nut meat segments is desired, one merely unsnaps the top section from the tube, adds more nut meats and then re-clicks the top on for operation.

The apparatus of this patent application is specifically designed to carry out the function of grinding shelled walnuts and preferably those of the Chandler variety and the meats of other nuts, such as pecans and almonds into small particles for use of the ground walnuts etc. on ice cream sundaes, in salads, in gourmet cooking recipes and in foods for young children. Peanuts are usually too oily as are other walnut varieties to provide good particle size reduction without dirtying up the interior of the tube and other parts of the device.

While the tab and notch for releaseable engagement of the top section to the central section has been discussed as one in number, a pair of each is also contemplated for oversize devices of this invention such as would be used in restaurants for show.

These devices may be made in any desired color. The preferably central section may be polycarbonate or polymethacrylate.

Since certain changes may be made in the above described apparatus without departing from the scope of the invention herein involved, it is intended that matter contained in the above description and shown in the accompanying drawings should be interpreted as illustrative and not in a limiting sense.

1. A grinder for the meats of shelled walnuts, almonds, pecans, peanuts, and the like, which comprises:
a body having an upper portion, a cylindrical center, and a bottom portion, said upper portion having a central throughbore, and said bottom portion having a central opening for receipt of a cutter,
said upper portion being engaged to said central portion and said central portion being engaged to said lower portion,
said grinder having a rotatable shaft the first end being disposed through said upper portion's central throughbore for connection to a crank for rotation of the shaft,
said shaft's bottom end being disposed through said central portion and connected at its second end to the said bottom portion,
said shaft having a dome-shaped cone cutter disposed at the second end of the shaft for rotational movement within the central opening of the bottom portion.

2. The device of claim 1, wherein the cutter cone has a series of openings each with a bulged-out cutter edge for reducing the particles size of nut meat disposed in the cylinder for disposition out the bottom of the device.

3. The device of claim 2, wherein the series of openings comprises a series of cutter edges set out in vertical sets of three.

4. The device of claim 3, wherein the series of cutter edges are in a plurality sets of three cutting edges at two distinct elevations.

5. The device of claim 2, wherein within the interior opening of the bottom portion are a series of upstanding spaced flutes that serve as guides to direct the nut meats toward the cutting edges of said cone cutter.

6. The device of claim 3, wherein within the central opening of the bottom portion vertically disposed along the interior wall of said bottom portion.

7. The device of claim 2, wherein the cone cutter has a bottom edge, and on said bottom edge is an edge protector disposed thereon by frictional engagement, said edge protector being disposed within the central opening of said bottom portion.

8. The device of claim 1, wherein central portion is preferably clear and contains at least one interior notch at the top upper edge thereof for engagement with a tab of the top section.

9. The device of claim 8, wherein a crank is disposed over the end of said shaft extended through the central opening of said upper portion.

10. The device of claim 1, wherein the top portion and the bottom portion are colored.

11. The device of claim 8, wherein a knob is disposed on said crank distant to said shaft.

12. The device of claim 1, wherein the dome shaped cone cutter comprises a cone cutter having a cutter holder attached thereto.

13. The device of claim 1 wherein the handle crank is integrated into a decorative overly for the top section, which overlay has a central bore for the shaft to stick through for engagement with a cap nut.

14. The device of claim 1 wherein the central tube is permanently affixed to the bottom section and the top section is releasably attached to the central section.
